(19) United States
(12) Patent Application Publication
(10) Pub. No.: US 2015/0234910 A1
(43) Pub. Date: Aug. 20, 2015

(54) LIFECYCLE MANAGEMENT AND PROVISIONING SYSTEM FOR UNIFIED COMMUNICATIONS

(71) Applicant: Unify Square, Inc., Bellevue, WA (US)

(72) Inventors: Oliver Schiff, Alfter (DE); Sudhanshu Aggarwal, Bellevue, WA (US)

(73) Assignee: Unify Square, Inc., Bellevue, WA (US)

(21) Appl. No.: 14/624,308

(22) Filed: Feb. 17, 2015

Related U.S. Application Data
(60) Provisional application No. 61/940,748, filed on Feb. 17, 2014.

(51) Int. Cl. G06F 17/30

(52) U.S. Cl. CPC G06F 17/30578; G06F 17/30377; G06F 17/30368

(57) ABSTRACT

A provisioning system automatically detects a new or updated object (e.g., a user object or a device object) in a data store associated with a unified communication (UC) system; reconciles attributes of the new or updated object; generates a change job based on a rule set; and causes a record corresponding to the new or updated object to be updated in the data store (or another data store in the UC system) based on the change job. Automatic detection of the new or updated object may involve importing data records from the data store and comparing them with corresponding records in a cached database. Reconciling the attributes may involve generating a template based on the rule set and comparing the template with the attributes. The provisioning system can detect a deviation between the template and the attributes and tailor the change job to resolve the deviation.

### CROSS-REFERENCE TO RELATED APPLICATION

This application claims the benefit of U.S. Provisional Patent Application No. 61/940,748, filed on Feb. 17, 2014, the disclosure of which is hereby incorporated by reference in its entirety.

### BACKGROUND

Unified communication (UC) systems allow users to communicate over internal networks (e.g., corporate networks) and external networks (e.g., the Internet) using a variety of integrated communication services, such as voice, video, and e-mail services. The successful integration of these services in a UC system provides greater ease and effectiveness of communication, both within and between organizations. However, because UC systems can cover highly complex organizations with large numbers of users using a variety of devices for communication, the deployment and ongoing maintenance of such systems remains challenging.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system performs automated provisioning of objects associated with a unified communication (UC) system. The computer system automatically detects a new or updated object (e.g., a user object or a device object) in a data store (e.g., active directory database). A rule engine reconciles attributes of the new or updated object and generates a change job based at least in part on a rule set configured to manage attributes of such objects. The computer system causes a record corresponding to the new or updated object to be updated in the data store (or another data store in the UC system) based at least in part on the change job.

Automatic detection of the new or updated object may involve importing data records corresponding to objects from the data store and comparing the imported data records with corresponding data records in a cached database. Reconciling the attributes of the new or updated object may involve generating a template based at least in part on the rule set, and comparing the template with the attributes. The computer system may then detect a deviation between the template and the attributes, and the change job may be tailored to resolve this deviation.

The computer system also can detect objects that may have been deleted from the data store, which can allow the computer system to release resources that were associated with the deleted objects, such as phone numbers, for future use.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a system diagram that depicts an illustrative provisioning system that performs automated provisioning of objects associated with a UC system;

FIG. 2 is a block diagram depicting an illustrative implementation of a rule engine in the illustrative provisioning system of FIG. 1;

FIG. 3 is a flow chart diagram of an automated provisioning process; and

FIG. 4 is a block diagram that illustrates basic aspects of a computing device appropriate for use in accordance with embodiments of the present disclosure.

### DETAILED DESCRIPTION

The following description provides details of an illustrative lifecycle management and provisioning system for unified communications. In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

### I. DESCRIPTION OF AN ILLUSTRATIVE UC LIFECYCLE MANAGEMENT AND PROVISIONING SYSTEM

In this section, an illustrative unified communication (UC) lifecycle management and provisioning system (referred to herein as a “provisioning system” for ease of discussion) is described. The illustrative provisioning system provides automated provisioning for UC services. As used herein, the terms “automatic,” “automated,” “automatically,” and related forms indicate that at least part of the respective functionality is performed without the need for user control. The illustrative provisioning system leverages a configurable set of rules to manage attributes of software objects (referred to herein simply as “objects”), such as user objects or device objects containing data relating to users and devices, respectively, associated with a UC system. The illustrative provisioning system also may serve other functions relating to the UC system, such as centrally managing phone numbers for communication devices of different types (e.g., telephones, fax machines, and the like), and establishing audit trails for changes and reporting. In at least one embodiment, the illustrative provisioning system employs a service-oriented architecture.

The illustrative provisioning system provides a highly automated approach to provisioning (preparation) and ongoing “evergreening” (maintenance) of UC-related objects, such as user objects or device objects. The illustrative provisioning system can be used independently or as part of an end-to-end workflow covering aspects of UC system migration, implementation, and use, such as data gathering, setup, provisioning, monitoring, end user surveys, reporting, and billing. As part of a larger UC system, the illustrative provisioning system can serve as a core component of an end-to-end approach, and can be used to steer and control vital parts of a site transformation or migration project. A holistic approach can tie together, automate, and significantly simplify many different aspects of UC operations, which are usually addressed separately.

### A. System Overview and Functionality

The illustrative provisioning system provides automated provisioning and management functions, which can be used for enabling UC deployment, operations, maintenance, etc. In use, the illustrative provisioning system can be coupled to an authoritative database/repository for UC resources (e.g., phone numbers, extensions, etc.) and user objects (e.g., from a directory). The illustrative provisioning system can use information such as profiles, personas, and rules to compute a resultant set of configurations for, e.g., users, devices, and UC systems (e.g., voice systems, video systems, meeting room systems provided in platforms such as Microsoft Lync® or Skype® for Business, etc.). The illustrative provisioning system has automation capabilities that can be used to provision, detect, and fix configuration drift and provide reporting capabilities around usage, provisioning activity and activity history.

The illustrative provisioning system can contribute to an overall automated approach to transformation and maintenance of individual sites as well as the related user population, and can be integrated with other services, as explained in further detail below, to enhance functionality related to, e.g., business intelligence, billing, voice or video quality, and end-user satisfaction.

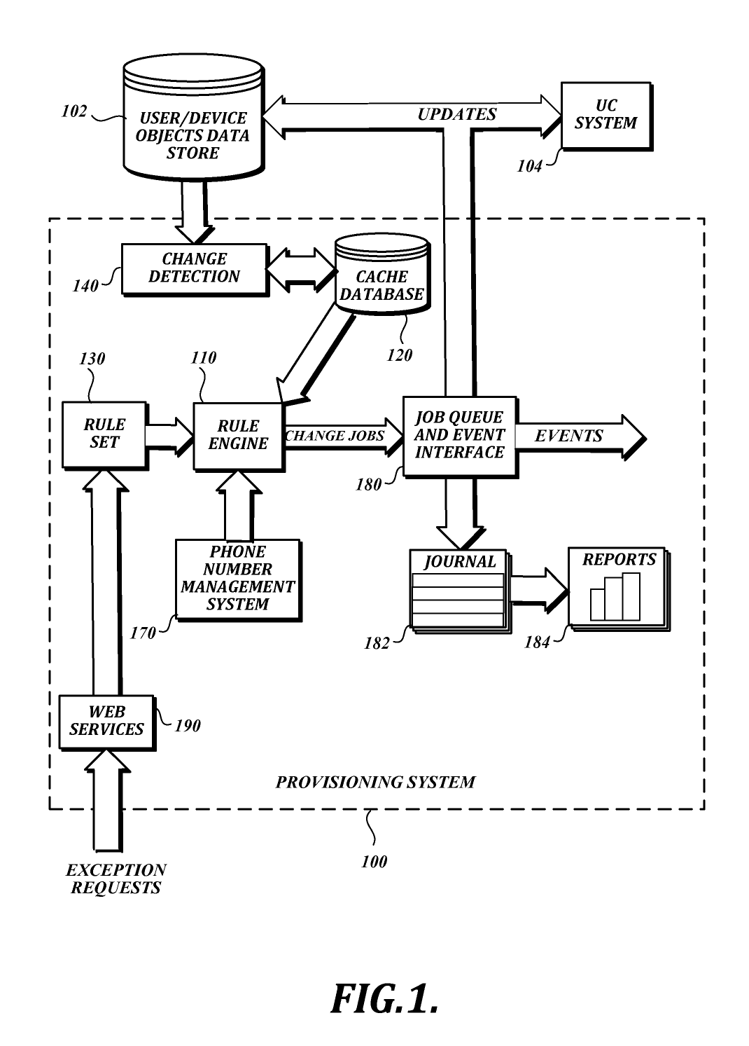

FIG. 1 is a system diagram that depicts an illustrative provisioning system 100 that performs automated provisioning of objects associated with a UC system 104. In the example shown in FIG. 1, the provisioning system 100 imports data records corresponding to objects (e.g., user objects or device objects) from an external data store 102 (that is, a data store outside the provisioning system 100) into the provisioning system 100. In at least one embodiment, the external data store 102 is a Microsoft® Active Directory database.

Within the provisioning system 100, a change detection module 140 compares newly imported records with corresponding records in an internal data store (e.g., cache database 120). New records (e.g., records that did not have a corresponding record in the cache database 120 before the current import) are marked (e.g., with a timestamp to indicate the time/date the new record was added) and automatically added to the cache database 120. Existing records are also marked (e.g., with a timestamp to indicate the time/date the existing record was updated) if one or more attributes in the newly imported version of the record have changed relative to the corresponding attributes in the cached record. In this case, the cache database 120 can be updated accordingly with the newly imported version of the record.

A rule engine 110 evaluates marked records from the cache database 120 against a rule set 130 that specifies one or more settings depending on predefined attributes of the objects. Such attributes may include location information (e.g., site, country, etc.), active directory (AD) group memberships, organizational information (such as department or cost center), etc. The rule engine 110 uses the rules and potentially other resources (such as a phone number management system 170) to identify deviations to be corrected and create corresponding change jobs, which are provided to a job queue and event interface 180. The rule engine 110 can match current settings of objects against calculated, rule-defined settings. Events can be raised to trigger appropriate actions to correct deviations and update records in the data store 102 or the UC system 104.

Alternatively, the provisioning system 100 may contain a different arrangement of components or perform automated provisioning processes in different ways.

Further details relating to these processes are provided below.

Data Import and Change Detection

The illustrative provisioning system includes user data import and change detection functionality. As explained above, the illustrative provisioning system can import current user or device data from an external data store into a cache database, and detect changes. The imported information can cover attributes relevant to provisioning of UC services, such as names and descriptions, e-mail addresses, phone numbers, group memberships, UC settings and configuration information, location information, etc. Other attributes also can be imported and handled, such as cost center, business group membership, or department information.

Referring again to FIG. 1, records that can be identified (or “seen”) in a source directory of the external data store 102 can be marked with a last-seen timestamp. Records that are updated or newly inserted in the cache database 120 can be marked with an update timestamp. The update timestamp allows the provisioning system 110 to be able to later process only newly added objects or objects that have been updated since the last time they were processed. The last-seen timestamp enables the provisioning system 110 to detect objects that have been deleted in the source directory. For example, a record representing an object that is not seen in the source directory because it has been deleted may lack a last-seen timestamp in the cache database. Marking records for deletion can facilitate reclaiming previously assigned resources, such as phone numbers, for future use.

Imported objects can be filtered, e.g., by the attributes described above. In the illustrative provisioning system, these filters can be defined as part of an import setup process and can describe either objects to include (objects that match some or all of the filter criteria) or to exclude (objects that do not meet some or all of the filter criteria). Objects that are filtered in this way can be regarded as “in scope” for the provisioning system. Other objects can be hidden and not processed. Attributes may be used for filtering purposes even if they are not used for provisioning.

Rule Engine

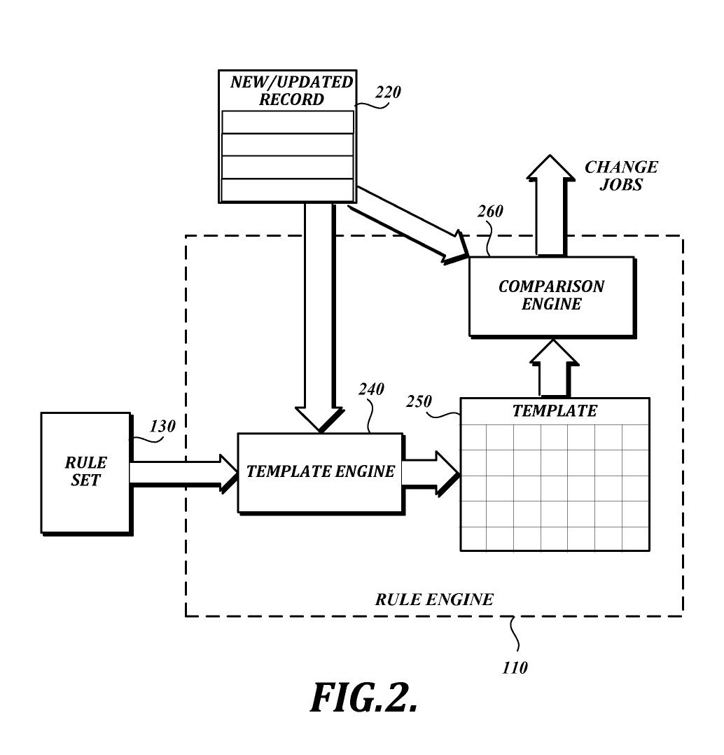

FIG. 2 is a block diagram depicting an illustrative implementation of the rule engine 110. In the example shown in FIG. 2, the rule engine 110 includes a template engine 240 and a comparison engine 260. The rule engine 110 uses the template engine 240 to generate a template 250 for a new or updated record 220 obtained from the cache database 120 (see FIG. 1) based on input from the rule set 130. The rule engine 110 then uses the comparison engine 260 to compare actual attributes of the new or updated record 220 with the template 250. If a deviation between the actual attributes and the template 250 is detected, the rule engine 110 can generate a change job as output. Alternatively, the rule engine 110 may contain a different arrangement of components or function in a different way.

In at least one embodiment, the rule engine 110 processes records from the cache database 120 in passes. The time at the beginning of a pass can be stored in memory and written to a settings table in the cache database 120 upon successful completion of the pass, allowing the rule engine 110 to keep track of when the last pass was conducted.

Rule Set

The illustrative provisioning system reconciles the user or device configuration against a calculated settings template, which can be defined by a set of rules. The illustrative provisioning system uses two types of rules: on/off rules and value rules. In the illustrative provisioning system, on/off rules specify UC client functionality that can either be available or denied (not available), such as video or application sharing. Value rules specify a value for a configuration parameter, such as the name of a policy. Alternatively, other rules may be used in addition to on/off rules and value rules.

In the illustrative provisioning system, on/off rules and value rules have a scope that defines which user or device objects the rule applies to. The scope uses previously defined user or device object attribute values (e.g., from 2 to 4 values), such as “country,” “site,” or “department” attribute values. The values for the scope need to match potential values of the respective user or device object attributes in the directory, or they may be a wildcard value (such as a null value).

On/off rules are stored in a rules table and have a set of attributes. Table 1, below, provides an illustrative set of attributes for an on/off rule.

TABLE 1
On/off rule attributes

| Label | Type |
|---|---|
| id | Number |
| service_id | Number |
| country | Text |
| site | Text |
| department | Text |
| enable | Boolean |
| active | Boolean |
| comments | Text |
| activation_date | DateTime |

The attributes shown in Table 1 include a rule identifier (“id”), a service identifier (“service_id”), a flag (“enable”) specifying whether the configuration set should be enabled or disabled, a flag (“active”) indicating whether the rule is currently active, a comment field (“comments”) that can hold a description of the rule, and an activation date (“activation_date”). In the illustrative provisioning system, rules that disable a service always override rules that enable the same service. Other attributes may include country information (“country”), site information (“site”), and department information (“department”).

In at least one embodiment, the service identifier maps to a previously defined configuration set, such as UC capabilities (e.g., “video” or “application sharing”) The configuration set can group capabilities into levels such as “basic,” “enhanced,” and “premium.” However, these capabilities can also be directly mapped to individual configuration settings of the UC system, e.g., “enabled for telephony.”

Value rules can be stored in a separate rules table and have a different set of attributes. Table 2, below, provides an illustrative set of attributes for a value rule.

TABLE 2
Value rule attributes

| Label | Type |
|---|---|
| id | Number |
| value_id | Number |
| country | Text |
| site | Text |
| department | Text |
| is_default | Boolean |
| active | Boolean |
| comments | Text |
| activation_date | DateTime |

The attributes for value rules shown in Table 2 include a value identifier (“value_id”) to identify the value that is to be configured and a flag (“is_default”) specifying whether this value should be regarded as the default value for the given scope.

It is possible to define several allowed values for a configuration setting. In the illustrative provisioning system, as long as a user or device object falls within the scope of a rule and matches one of the allowed values within the applicable rule, the current object setting will not be changed. If the currently configured object setting does not match any of the allowed values in the applicable rule, a value marked as a default value (e.g., as indicated by the Boolean value “is_default”) can be assigned.

In the illustrative provisioning system, on/off rules (turning features on or off) and value rules (specifying specific values for a setting) can be entered as an inactive rule with an activation date. The system can automatically activate a rule when the activation date has been reached. Rules that are in an inactive state can be ignored by the system.

Exceptions to Rules

In the illustrative provisioning system, rules can have exceptions for individual objects. The illustrative provisioning system allows overriding rules for specific user or device objects. To do this, an exception for the object can be entered. Referring again to FIG. 1, the illustrative provisioning system may allow exceptions to be entered manually (e.g., via a Web interface that sends corresponding requests to a Web services component 190 of the provisioning system 100). However, manual entry of exceptions is not required. In at least one embodiment, exceptions specify a unique identifier of the object, the service or functionality (workload) to be overridden, and the value with which to override the configuration.

In one illustrative scenario, a user is supposed to have access to a video service of the UC system, but the existing rule set denies the video feature for the user. An exception can be entered into the system to enable video for the user. The exception can override any existing rules for the video workload for that specific user object.

Exceptions may have the effect, in some scenarios, of removing user or device objects from the automated management of the provisioning system, at least with respect to a particular feature. Therefore, exceptions can be provided with a reasonable expiration date and can be renewed if needed. This can help prevent stale exceptions, which can lead to problems, such as in cases where features are enabled for individuals who move to sites where these features must be denied. Stale exceptions can even lead to legal noncompliance. For example, if an exception to denial of a VoIP (voice-over-IP) service never expires, this may lead to legal problems if the user moves to a country where VoIP is legally prohibited.

The illustrative provisioning system can automatically remove exceptions that have expired.

Reconciliation

Referring again to FIG. 2, a reconciliation process is now described. As previously explained, timestamps can be used to allow the rule engine 110 to keep track of when the last pass was conducted. To reconcile the current configuration settings in the user/device directory, records in the cache database 120 (see FIG. 1) that have an update timestamp greater than the timestamp of the last pass can be re-evaluated against rules in the rule set 130. For each such user or device object from the cache database 120, a template 250 can be calculated (e.g., by a template engine 240 of the rule engine 110) that applies applicable rules. The template 250 contains possible settings for the respective objects, e.g., on/off features and configuration values.

The rule engine 110 can resolve a defined service into individual configuration settings. The values can be applied according to applicable rules. For the on/off rules, a service (e.g., as defined by the individual configuration settings) can be enabled, disabled, or undefined. In at least one embodiment, rules that disable the service override any rules that enable the service. However, exceptions are not regarded as rules. Therefore, in at least one embodiment, exceptions can override any setting, regardless of whether that setting is enabled or disabled. Value rules can be processed in a “most-specific-to-least-specific” order until a value has been defined. In at least one embodiment, if no rule applies, the value is undefined. Undefined settings can be left unchanged, e.g., the respective user or device object's attributes can be left unchanged.

The template 250 can be reconciled (e.g., by the comparison engine 260 of the rule engine 110) with the actual settings of the user or device object from the cache database 120. Undefined attributes can be ignored in this process. If the system detects deviations between template and object, the system can take appropriate actions to make changes to correct these deviations, as explained in further detail below.

Change Jobs

If changes are required, most values can simply be overwritten with the desired value. To overwrite values, the illustrative provisioning system issues change jobs. Referring again to the example shown in FIG. 1, the rule engine 110 generates change jobs and provides them as input a job queue. Change jobs contain information to facilitate the change, such as an object identifier, an identifier of the attribute to be changed, and old and new values. The illustrative provisioning system applies changes by executing the changes according to the jobs in the queue. The new values can be written in different locations. For example, new values can be written to an active directory in the external data store 102, or directly to the UC system 104, depending on where the respective configuration settings for a user or device are stored.

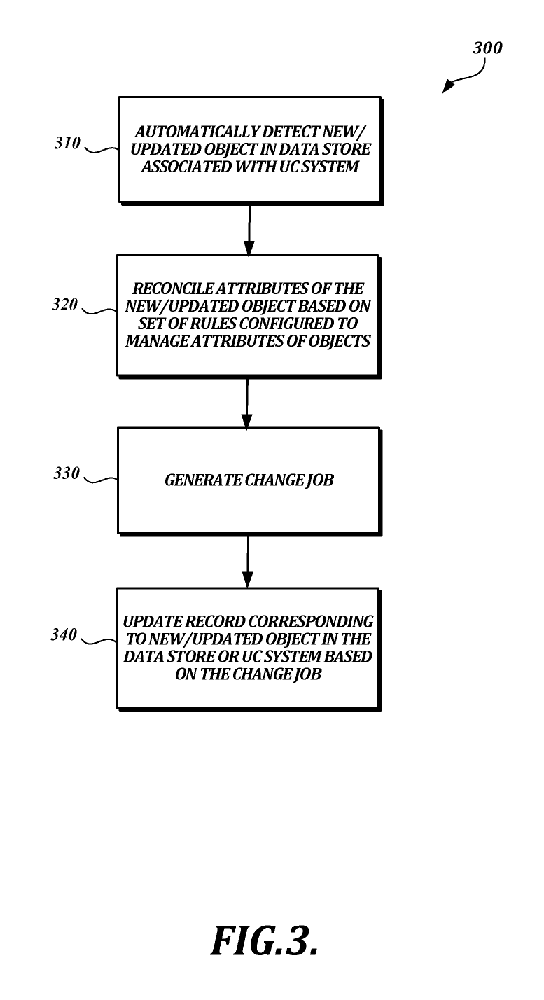

FIG. 3 is a flow chart diagram of an illustrative automated provisioning process 300 that can be carried out by the illustrative provisioning system to automatically detect and reconcile new or updated objects and apply changes described in change jobs generated by the provisioning system. At step 310, the provisioning system automatically detects a new or updated object in a data store (e.g., data store 102) associated with a UC system. At step 320, the provisioning system, which may include a rule engine such as rule engine 110, reconciles attributes of the new or updated object based on a set of rules configured to manage attributes of such objects and, at step 330, generates a change job. At step 340, the provisioning system updates a record in the data store (or in some other location, such as another data store in the UC system 104) that corresponds to the new or updated object, based on the change job.

Changes supported by the illustrative provisioning system include changes to telephone functionality. For example, configuration settings may enable or disable the use of telephone functionality. In at least one embodiment, enabling or disabling telephone functionality requires that the user or device object is configured with a phone number. The illustrative provisioning system can leverage an underlying phone number management system to retrieve or return phone numbers. For example, to assign a number, the illustrative provisioning system queries the phone number management system for an available number and for a given location (e.g., the physical location of the object requiring the number as configured in the source data store, such as the data store 102 in FIG. 1). The phone number management system then returns an available number (e.g., a specifically requested number, the next available number in a list of available numbers, etc.). Once the illustrative provisioning system has written the number to the object's attribute, it can mark the number as “assigned” in the phone number management system.

Deleted Objects

In the illustrative provisioning system, objects can be deleted or removed from scope, which may require further action on the part of the system. For example, objects that have been removed from scope or have been deleted may have their phone number revoked, if applicable. To do this, the illustrative provisioning system deletes the assignment of the phone number in the phone number management system. The illustrative provisioning system can attempt to find the object in the directory without applying the scope filter. If the object is found, the phone number can be removed from the object.

Events

The illustrative provisioning system creates events for changes that are detected. Other programs (e.g., PowerShell or programs based on the .NET Framework, available from Microsoft Corp.) can subscribe to these events and execute additional actions. The events can be documented and the event objects can pass along information about the type of event, as well as additional, meaningful context. For example, the system can issue an event if a user object's or device object's configured phone number was updated because the originally configured number no longer matched the location configured for the object.

Events can allow an organization that uses the illustrative provisioning system to attach or integrate existing workflows in a flexible way. In the number-change example described above, a script may register for this event and, if the event is detected, initiate actions such as updating additional phone directories (which can be external to the system) or sending a message (e.g., an e-mail) to inform an administrator about the change.

Journaling

In the illustrative provisioning system, changes made by the provisioning system can be recorded in a data store called a journal. Referring again to the example shown in FIG. 1, a journal 182 receives information (e.g., change job information, events, etc.) from the job queue and event interface 180. The journal 182 facilitates generation of reports 184 about general provisioning statistics (e.g., how many users or device objects have been configured during the last month), and also can provide detailed audit trails for potential issue analysis (e.g., “why was user x configured for service y on day z”). The journal 182 can include descriptions of configuration changes, as well as a record of rules that led to the respective changes.

Phone Number Management System

Phone numbers can be an important part of a provisioning solution. They can be regarded as shared resources, because they are potentially shared with other systems, such as public branch exchanges (PBXs), fax machines, etc. Referring again to the example shown in FIG. 1, the provisioning system 100 includes a phone number management system 170 that can track the usage and availability of phone numbers and the ranges to which they belong. In addition, ranges can be associated with locations for which the individual numbers can be used.

In the illustrative provisioning system, the availability of a phone number can be classified as “uninitialized,” “used,” “free/available,” or “special.” The availability of newly entered numbers is “uninitialized.” The system can use tools such as configurable regular expressions to mark certain numbers as “special,” such as easy-to-remember extension numbers like “1000,” “2000,” etc. Special numbers can be restricted or reserved for special purposes. For example, special numbers may not be assigned by the system automatically, but can be assigned manually. Other numbers that are not in use can be marked as “free” and can be assigned by the system automatically as they are needed. It is also possible for numbers to be classified in more than one way (e.g., “free” and “special,” “used” and “special,” etc.)

The availability “used” is derived from one or more states, which can be determined by individual phone number usages. In the illustrative provisioning system, usages can be “assigned,” “reserved,” or “tombstoned.” A single phone number can have multiple assignments, “tombstones” or reservations, which can be managed individually. These states can include a unique, freely definable identifier, which can be a user name, a session initiation protocol (SIP) address, or any other unique identifier. In addition, an assignment can be “tombstoned” together with an expiration date. A phone number with a tombstone record cannot be assigned or reserved. After the tombstone entry expires, the number availability can be returned to “free” or “special.”

All information can be stored in a database to enable programmatic and controlled access, as well as to ensure data integrity.

### B. End-to-End Transformation Scenario

The illustrative provisioning system can be integrated with other services and systems. Such integration can provide additional benefits and efficiencies for organizations that use UC systems.

In one illustrative scenario, the illustrative provisioning system can be used as part of an end-to-end UC services transformation workflow. This workflow can involve site analysis and design, implementation, monitoring, maintenance or correction of open issues, surveys, reporting, and billing.

Site Analysis and Design Phase

To deploy a UC solution, an organization can be first segmented into locations or sites. The sites' requirements can drive changes and setup of IT systems, such as gateways, network upgrades, or firewall configuration. During the planning phase of a site, information about current capabilities, existing requirements, and existing IT infrastructure can be gathered in a structured manner. This data can be used by a service deployment program to create site-specific designs and a UC rollout plan. These site designs can describe the capabilities of a site, such as whether telephony or video communication can be supported. In addition, information about currently configured phone numbers, available ranges, and their exact locations may be available.

UC service deployment programs can provide many functions for deployment of UC services, such as voice or video services. As an example, a voice service deployment program may include:
Global voice design: A global standard for voice communications within the enterprise can be defined prior to automated voice migration for each site commencing.
Country-specific voice design: The migration may include country-specific optimizations, depending on the systems that are used and the resources that are available within a given country.
Site-specific designs: Site design can start with standardized data gathering and can end with a package for actual site migration which may include hardware order lists, configuration files (e.g., for gateways), cabling instructions, test lists, and the like, and may also include special solutions for non-standard requirements.

For more information on voice or video deployment systems that may be used in combination with the illustrative provisioning system, see U.S. patent application Ser. No. 14/XXX,YYY, filed concurrently herewith, which claims the benefit of U.S. Provisional Patent Application No. 61/940,722, entitled “Unified Communication Voice Deployment System,” filed on Feb. 17, 2014, the disclosures of which are incorporated herein by reference.

Post-Design Phase (Implementation and Roll-Out)

Data from a site analysis and design phase may be used by the illustrative provisioning system, and it can be imported directly to backend databases. For example, a site analysis and design can yield information about available phone number ranges and the fact that the network will be able to support particular workloads (e.g., video communication). In this example, the information can be used to automatically enter the available phone number ranges into the phone number management system, as well as to create a site-specific rule to allow video communication. The site roll-out plan may include a migration date that can be used as an “activation date” for rules, as described herein. When the activation date for a rule is reached, the illustrative provisioning system can activate the rule and configure applicable user or device objects automatically.

Monitoring and Resolution of Open Issues

A freshly migrated site will likely require configuration fine tuning in regards to firewall and gateway configuration, possibly network configuration, etc. Accordingly, the illustrative provisioning system may be used in combination with a monitoring service such as PowerMon™, a cloud-based monitoring solution available from Unify Square, Inc., which can test specific end-to-end UC scenarios, such as telephone calls through specified gateways or peer-to-peer or conferencing audio sessions. The monitoring service may further provide voice or video quality metrics and, in case of failures, detailed information about the failure source.

In an illustrative scenario, after the illustrative provisioning system has enabled a site (via applicable rules) for a workload involving voice, conferencing, or public switched telephone network (PSTN) telephony, the system can also automatically provision a monitoring service to monitor the newly migrated site. This can be done through web services provided by the monitoring service. The illustrative provisioning system can create time-limited test rules within the monitoring service and supply applicable contact information, to which potential alerts or failure alarms can be delivered. An operations team can then correct any open issues.

Quality/Satisfaction Surveys

A UC system can trigger a survey about perceived service quality to users impacted by a recent migration or transformation to measure end-user satisfaction and discover potential user issues that may not be measurable by monitoring systems. The interval for this trigger can be configurable and may be configured to occur, e.g., 30 days after the start of an issue-correction phase.

The end-user surveys can be conducted using a survey service, such as PowerSat™, a cloud-based, instant messaging-based survey solution available from Unify Square, Inc. The survey service may supply web services for provisioning, which can be used to configure parameters such as the survey content, survey length, and target audience. The audience can be derived from the user objects affected by a rule that initially enabled the new services.

Reporting and Billing

Once a site has been migrated or transformed, the usage of the UC system, its adoption by users, and other characteristics such as service quality, phone number utilization, and PSTN billing charges can be reported. Reports about phone number utilization (e.g., phone number range utilization) may be important for future planning, e.g., if the user population on a site grows. A service such as PowerView™, available from Unify Square, Inc., can provide such reports. For example, service quality reports can be generated by accessing UC databases that contain session and quality information (e.g., call details record (CDR) information). Additionally, the system's internal databases, such as a journal or phone number database, can provide provisioning statistics or other information, such as an overview of phone number usage.

For more information on UC system monitoring services, quality and satisfaction surveys, and reporting and billing services, see U.S. patent application Ser. No. 14/179,476, entitled “Advanced Tools for Unified Communication Data Management and Analysis,” filed on Feb. 12, 2014, the disclosure of which is incorporated herein by reference.

### II. ILLUSTRATIVE DEVICES AND OPERATING ENVIRONMENTS

Unless otherwise specified in the context of specific examples, described techniques and tools may be implemented by any suitable computing device or set of devices.

In described examples, an engine includes logic (e.g., in the form of computer program code) configured to cause one or more computing device(s) to perform actions described herein as being associated with the engine. For example, a computing device can be specifically programmed to perform the actions by having installed therein a tangible computer-readable medium having computer-executable instructions stored thereon that, when executed by one or more processors of the computing device, cause the computing device to perform the actions. The particular engines described herein are included for ease of discussion, but many alternatives are possible. For example, actions described herein as associated with two or more engines on multiple devices may be performed by a single engine. As another example, actions described herein as associated with a single engine may be performed by two or more engines on the same device or on multiple devices.

In any of the described examples, a data store contains data as described herein and may be hosted, for example, by a database management system (DBMS) to allow a high level of data throughput between the data store and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location.

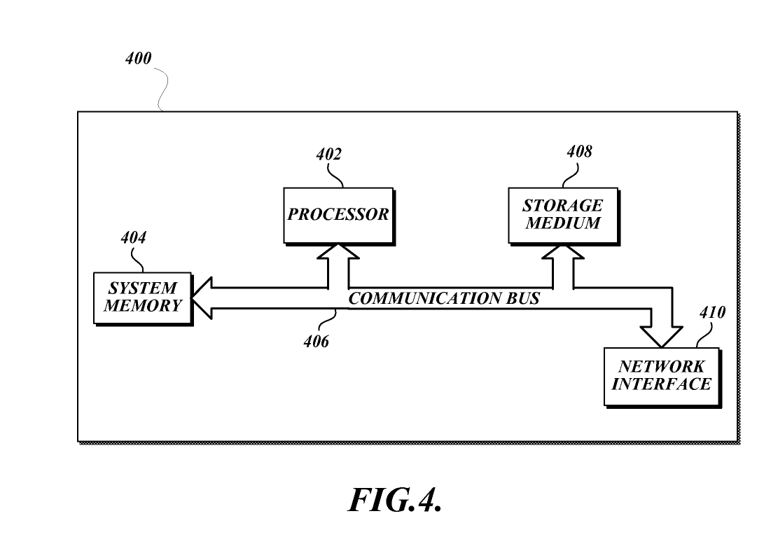

FIG. 4 is a block diagram that illustrates aspects of an illustrative computing device 400 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 400 includes at least one processor 402 and a system memory 404 connected by a communication bus 406. Depending on the exact configuration and type of device, the system memory 404 may be volatile or nonvolatile memory, such as read only memory (“ROM”), random access memory (“RAM”), EEPROM, flash memory, or other memory technology. Those of ordinary skill in the art and others will recognize that system memory 404 typically stores data and/or program modules that are immediately accessible to and/or currently being operated on by the processor 402. In this regard, the processor 402 may serve as a computational center of the computing device 400 by supporting the execution of instructions.

As further illustrated in FIG. 4, the computing device 400 may include a network interface 410 comprising one or more components for communicating with other devices over a network. Embodiments of the present disclosure may access basic services that utilize the network interface 410 to perform communications using common network protocols. The network interface 410 may also include a wireless network interface configured to communicate via one or more wireless communication protocols, such as WiFi, 2G, 3G, 4G, LTE, WiMAX, Bluetooth, and/or the like.

In the illustrative embodiment depicted in FIG. 4, the computing device 400 also includes a storage medium 408. However, services may be accessed using a computing device that does not include means for persisting data to a local storage medium. Therefore, the storage medium 408 depicted in FIG. 4 is optional. In any event, the storage medium 408 may be volatile or nonvolatile, removable or non-removable, implemented using any technology capable of storing information such as, but not limited to, a hard drive, solid state drive, CD-ROM, DVD, or other disk storage, magnetic tape, magnetic disk storage, or the like.

As used herein, the term “computer-readable medium” includes volatile and nonvolatile and removable and non-removable media implemented in any method or technology capable of storing information, such as computer-readable instructions, data structures, program modules, or other data. In this regard, the system memory 404 and storage medium 408 depicted in FIG. 4 are examples of computer-readable media.

For ease of illustration and because it is not important for an understanding of the claimed subject matter, FIG. 4 does not show some of the typical components of many computing devices. In this regard, the computing device 400 may include input devices, such as a keyboard, keypad, mouse, trackball, microphone, video camera, touchpad, touchscreen, electronic pen, stylus, or the like. Such input devices may be coupled to the computing device 400 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 400 (e.g., a client device), or can be integral components of the computing device 400. In some embodiments, multiple input devices may be combined into a single, multifunction input device (e.g., a video camera with an integrated microphone). Any suitable input device either currently known or developed in the future may be used with systems described herein.

The computing device 400 may also include output devices such as a display, speakers, printer, etc. The output devices may include video output devices such as a display or touchscreen. The output devices also may include audio output devices such as external speakers or earphones. The output devices can be separate from and communicatively coupled to the computing device 400, or can be integral components of the computing device 400. In some embodiments, multiple output devices may be combined into a single device (e.g., a display with built-in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft .NET™ languages such as C#, or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### III. EXTENSIONS AND ALTERNATIVES

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The elements shown in the user interfaces can be modified, supplemented, or replaced with other elements in various possible implementations.

### IV. ILLUSTRATIVE EMBODIMENTS

Embodiments disclosed herein include:
A computer-implemented method for performing one or more of the above-described techniques.
A server computer comprising a processing unit and computer-readable storage media having stored thereon computer-executable instructions configured to cause the server computer to perform one or more of the above-described techniques.
A computer-readable storage medium having stored thereon computer-executable instructions configured to cause a computing device to perform one or more of the above-described techniques.
A computer system comprising a server that provides one or more of the above-described services. The computer system may further comprise plural client computing devices.
A client computing device in communication with a server that provides one or more of the above-described services, the client computing device comprising a processing unit and computer-readable storage media having stored thereon computer-executable instructions configured to cause the client computing device to perform one or more of the above-described techniques.

While illustrative embodiments have been illustrated and described, it will be appreciated that various changes can be made therein without departing from the spirit and scope of the claimed subject matter.

The embodiments of the invention in which an exclusive property or privilege is claimed are defined as follows:

1. A computer system comprising one or more processors and computer-readable media having stored thereon computer-executable instructions configured to cause the computer system to:
automatically detect a new or updated object in a data store associated with a unified communication system, wherein the new or updated object comprises one or more attributes;
reconcile the one or more attributes of the new or updated object and generate a change job based at least in part on a rule set; and
cause a record corresponding to the new or updated object to be updated in the data store or another data store in the unified communication system based at least in part on the change job.

2. The computer system of claim 1, wherein the computer-executable instructions are further configured to cause the computer system to:
import data records corresponding to a plurality of objects from the data store; and
compare the imported data records with corresponding data records in a cached database to automatically detect the new or updated object.

3. The computer system of claim 1, wherein reconciling the one or more attributes of the new or updated object comprises:
generating a template based at least in part on the rule set; and
comparing the template with the one or more attributes of the new or updated object.

4. The computer system of claim 3, wherein the computer-executable instructions are further configured to cause the computer system to detect of a deviation between the template and the attributes of the new or updated object.

5. The computer system of claim 1, wherein the data store comprises an active directory database.

6. The computer system of claim 1, wherein the new or updated object comprises a user object or a device object.

7. The computer system of claim 1, wherein the computer-executable instructions are further configured to cause the computer system to:
import data records corresponding to a plurality of objects from the data store;
compare the imported data records with data records in a cached database; and
detect an object that was deleted from the data store.

8. The computer system of claim 7, wherein the computer-executable instructions are further configured to cause the computer system to delete an assignment of a phone number associated with the deleted object in a phone number management system.

9. A computer-implemented method comprising:
by a computer system comprising at least one computing device, automatically detecting a new or updated object in a data store associated with a unified communication system, wherein the new or updated object comprises one or more attributes;
by the computer system, reconciling the one or more attributes of the new or updated object based at least in part on a rule set;
by the computer system, generating a change job in response to the reconciling; and
by the computer system, causing a record corresponding to the new or updated object to be updated in the data store or another data store in the unified communication system based at least in part on the change job.

10. The method of claim 9, further comprising centrally managing phone numbers in the unified communication system.

11. The method of claim 9, wherein the method is performed as part of a unified communication system migration.

12. The method of claim 9, further comprising importing data records corresponding to a plurality of objects from the data store, wherein automatically detecting the new or updated object comprises comparing the imported data records with corresponding data records in a cached database.

13. The method of claim 9, wherein reconciling the one or more attributes of the new or updated object comprises:
generating a template based at least in part on the rule set; and
comparing the template with the attributes of the new or updated object.

14. The method of claim 13, further comprising detecting a deviation between the template and the new or updated object.

15. The method of claim 9, wherein the data store comprises an active directory database.

16. The method of claim 9, wherein the new or updated object comprises a user object or a device object.

17. The method of claim 9, further comprising:
importing data records corresponding to a plurality of objects from the data store;
comparing the imported data records with data records in a cached database; and
based on the comparing, detecting an object that was deleted from the data store.

18. The method of claim 17, further comprising deleting an assignment of a phone number associated with the deleted object in a phone number management system.
